(19) United States
(12) Patent Application Publication
(10) Pub. No.: US 2018/0202281 A1
(43) Pub. Date: Jul. 19, 2018

(54) LOCATING WELLBORE FLOW PATHS BEHIND DRILL PIPE

(71) Applicant: Halliburton Energy Services, Inc., Houston, TX (US)

(72) Inventors: Michel Joseph LEBLANC, Houston, TX (US); Neal Gregory SKINNER, Lewisville, TX (US); James Randolph LOVORN, Tomball, TX (US)

(73) Assignee: Halliburton Energy Services Inc., Houston, TX (US)

(21) Appl. No.: 15/743,651

(22) PCT Filed: Aug. 12, 2015
(86) PCT No.: PCT/US2015/044801

§ 371 Date: Jan. 10, 2018

(51) Int. Cl. E21B 47/00; E21B 47/06; E21B 47/12; E21B 47/10; E21B 21/08; G01D 5/353; G01K 11/32; G02B 6/43; G02B 6/42; G02B 6/02

(52) U.S. Cl. CPC E21B 47/0005; E21B 47/065; E21B 47/0006; E21B 47/123; E21B 47/102; E21B 21/08; E21B 19/008; G01D 5/35316; G01K 11/3206; G02B 6/43; G02B 6/4202; G02B 6/02076; E21B 47/06

(57) ABSTRACT

A drilling system includes a string of drill pipe extending into a wellbore from a drilling platform. A Y-block junction is coupled to the string of drill pipe at the drilling platform and provides a pressure housing that defines a first conduit and a second conduit that converges with the first conduit. The pressure housing further defines an outlet configured to be coupled to the string of drill pipe extending into the wellbore. A lubricator is operatively coupled to the Y-block junction at the second conduit, and a cable having one or more optical fibers embedded therein is conveyed into the wellbore within the string of drill pipe via the lubricator and the Y-block junction.

### BACKGROUND

To produce hydrocarbons from subterranean formations, a wellbore is drilled through the subterranean formations to a desired depth. This can be accomplished with a drill bit coupled to the distal end of a string of drill pipe. One or more orifices are typically defined in the body of the drill bit to allow fluid flow through the drill bit. As a result, a drilling fluid or “mud” is able to be circulated through the drill pipe from a drilling rig at the Earth's surface, out the orifices of the drill bit, and subsequently returned to the surface via an annulus defined between the drill pipe and a wall of the wellbore. The drilling fluid serves several purposes, including removing cuttings and wellbore debris from the wellbore during drilling and cooling the drill bit.

During drilling operations, it is important to control the fluid pressure within the wellbore, which is typically regulated with respect to the pressure exhibited by the formation or the “pore pressure.” Wellbore pressure can be controlled through a combination of mud weight, mud flow rate, and the use of chokes to control the flow of the drilling fluid within the annulus. Wellbore pressure can be quickly modified by selectively varying the mud flow rate and the choke settings.

The well is considered “balanced” when the wellbore pressure and the pore pressure are equal. When the pore pressure is greater than the wellbore pressure, the well is considered underbalanced, which could result in an undesirable blowout or “kick” of fluid toward the surface of the wellbore. In contrast, when the wellbore pressure is greater than the pore pressure, the well is considered overbalanced, which could result in the drilling fluid pumped downhole flowing into the formation and thereby causing loss of valuable fluids as well as an eventual decrease in productivity of the formation. In extreme cases of overbalance, sufficient fluid can be lost to the formation where the height of the column of drilling fluid in the annulus falls to the point where the hydrostatic pressure on the formation is so low that a blowout or “kick” can develop. It is also possible for fluid flow to occur between two zones within the wellbore, where the fluid exits the wellbore at one point and subsequently enters the wellbore at another, and thereby causing crossflow. When any of these conditions exist, it is important that the well operator fully understands what is happening downhole and whether flow paths exist between the wellbore and the formation.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is an exemplary drilling system that may employ the principles of the present disclosure.

FIG. 2 is an enlarged view of an exemplary portion of the drilling system of FIG. 1.

FIGS. 3A and 3B are cross-sectional end views of two exemplary cables.

FIG. 4 is a cross-sectional view of an exemplary well system that may employ the principles of the present disclosure.

FIG. 5 is a cross-sectional view of another exemplary well system that may employ the principles of the present disclosure.

### DETAILED DESCRIPTION

The present disclosure is related to equipment used during wellbore drilling operations and, more particularly, to using a cable having optical fibers embedded therein to detect flow paths beyond drill pipe.

The embodiments described herein provide a drilling system that allows distributed acoustic and/or temperature measurements to be made within drill pipe while circulating drilling fluid. A Y-block junction may be coupled to the string of drill pipe and includes a pressure housing that defines a first conduit and a second conduit that converges with the first conduit. The pressure housing further defines an outlet configured to be coupled to the string of drill pipe extending into the wellbore. A lubricator may be operatively coupled to the Y-block junction at the second conduit, and a cable having one or more optical fibers embedded therein may be conveyed into the wellbore within the string of drill pipe via the lubricator and the Y-block junction. Once the Y-block junction and the lubricator are successfully installed in the string of drill pipe, drilling fluid flow may be returned to the string of drill pipe and distributed acoustic and/or temperature measurements to be made within drill pipe with the optical fibers while circulating the drilling fluid.

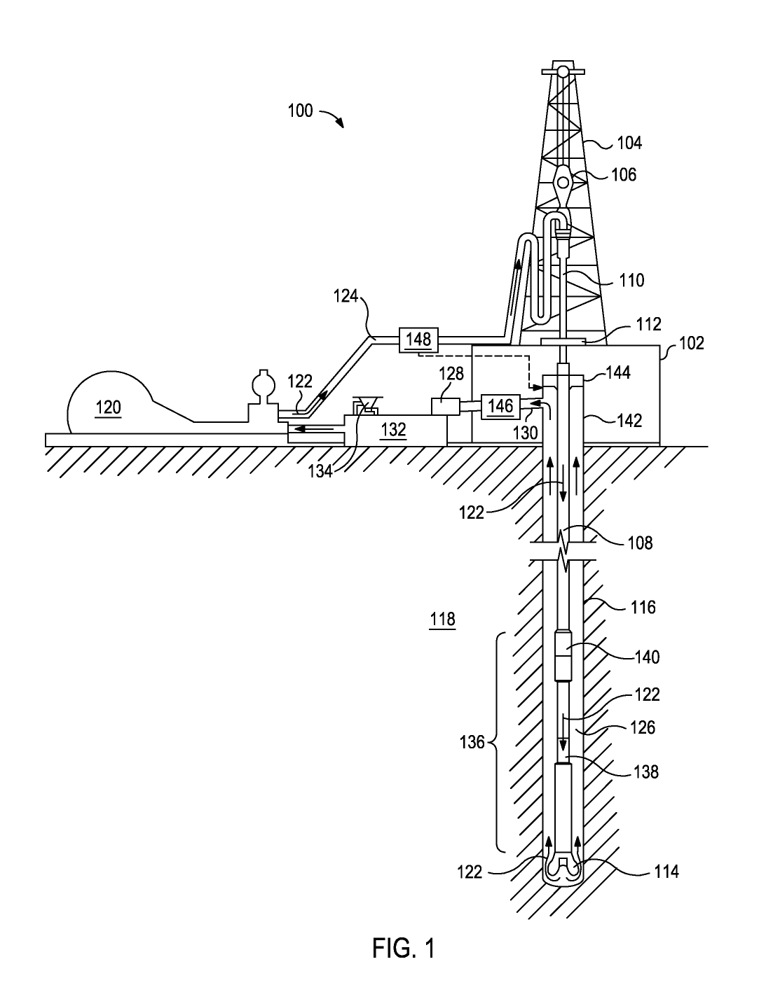

Referring to FIG. 1, illustrated is an exemplary drilling system 100 that may employ the principles of the present disclosure. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure. As illustrated, the drilling system 100 may include a drilling platform 102 that supports a derrick 104 having a traveling block 106 for raising and lowering string of drill pipe 108. The drill pipe 108 may include several lengths of pipe connected end to end to form an elongate pipe string used for drilling purposes. In some embodiments, the drill pipe 108 may be replaced with other common downhole tubulars or piping such as, but not limited to, casing, a wellbore liner, or coiled tubing, without departing from the scope of the disclosure. A kelly 110 supports the drill pipe 108 as it is lowered through a rotary table 112. A drill bit 114 is attached to the distal end of the drill pipe 108 and is driven either by a downhole motor and/or via rotation of the drill pipe 108 from the well surface. As the bit 114 rotates, it creates a wellbore 116 that penetrates various subterranean formations 118.

One or more rig pumps 120 (alternately referred to as “mud pumps”) circulate drilling fluid 122 (alternately referred to as “mud”) through a feed pipe 124 and to the kelly 110, which conveys the drilling fluid 122 downhole through the interior of the drill pipe 108 and through one or more orifices in the drill bit 114. The drilling fluid 122 is then circulated back to the surface via an annulus 126 defined between the drill pipe 108 and the walls of the wellbore 116. At the surface, the recirculated drilling fluid 122 exits the annulus 126 and may be conveyed to one or more fluid processing unit(s) 128 via an interconnecting return line 130. After passing through the fluid processing unit(s) 128, a “cleaned” drilling fluid 122 is deposited into a nearby retention pit 132 (i.e., a mud pit). One or more chemicals, fluids, or additives may be added to the drilling fluid 122 via a mixing hopper 134 communicably coupled to or otherwise in fluid communication with the retention pit 132.

The drilling system 100 may further include a bottom hole assembly (BHA) 136 arranged in the string of drill pipe 108 at or near the drill bit 114. The BHA 136 may include any of a number of sensor modules 138, which may include formation evaluation sensors and directional sensors, such as a measuring-while-drilling (MWD) tool, a logging-while-drilling (LWD) tool, and a pressure-while-drilling (PWD) tool. These sensor modules 138 generally provide wellbore parameters, such as pressure and temperatures, but may also detect drill string characteristics (e.g., vibration, weight on bit, stick-slip, orientation, etc.), formation 118 characteristics (e.g., resistivity, density, etc.) and/or other downhole measurements.

In some embodiments, the BHA 136 may also include a telemetry module 140 used to transmit downhole sensor measurements derived from the sensor modules 138 to the surface via various forms of telemetry (e.g., acoustic, pressure pulse, etc.). In at least one embodiment, the telemetry module 140 comprises a mud pulser system that operates by encoding sensor data in the form of pressure fluctuations in the column of drilling fluid 122 present in the drill pipe 108, and thereby transmitting the data to the surface. At the surface, the pressure pulses are detected by one or more surface sensors (not shown) and interpreted to provide the measured downhole data.

Control of bottom hole pressure (BHP) or wellbore pressure is an important aspect in managed pressure and underbalanced drilling operations. Preferably, the bottom hole pressure (i.e., pressure at or near the drill bit 114) is accurately controlled to prevent a variety of undesirable events, such as excessive loss of the drilling fluid 122 into the surrounding formation 118, fracturing of the formation 118, and the influx of fluids from the formation 118 into the wellbore 116. In typical managed pressure drilling, it is desired to maintain the bottom hole pressure within the annulus 126 (i.e., the wellbore pressure) slightly above the pressure of the formation 118 (i.e., the pore pressure) without exceeding the fracture pressure gradient of the formation 118.

In the illustrated drilling system 100, the wellbore pressure may be at least partially maintained by closing off the annulus 126 at a wellhead 142 installed at the surface and by using a rotating control device 144 to seal about the drill pipe 108 above the wellhead 142 as the drill pipe 108 rotates and advances into the wellbore 116. The wellhead 142 may also include a blowout preventer (BOP) stack (not expressly shown), as generally known in the art. As illustrated, the return line 130 may be fluidly coupled to the wellhead 142 to receive the drilling fluid 122 returning to the surface and otherwise exiting the annulus 126. The returned drilling fluid 122 may be received by and conveyed through a choke manifold 146 fluidly coupled to the return line 130. The choke manifold 146 may include one or more redundant chokes that may be selectively operated to variably restrict the flow of the drilling fluid 122 and thereby apply a desired backpressure on the annulus 126 to regulate the wellbore pressure.

In some cases, the drilling system 100 may further include a rig pump diverter 148 (alternately referred to as a rig pump diverter manifold). The rig pump diverter 148 may be configured to divert the drilling fluid 122 back into the annulus 126 when activated and needed, such as when connections are being made in the string of the drill pipe 108, and thereby enable continuous control of the wellbore pressure. More particularly, the rig pump diverter 148 is able to divert the flow from the rig pumps 120 between circulating down the drill pipe 108 to circulation at the surface, and thereby allowing continuous flow through the choke manifold 146 to regulate the backpressure on the annulus 126. The choke manifold 146 and the rig pump diverter 148 may operate together to regulate the wellbore pressure within a predetermined pressure threshold.

According to embodiments of the present disclosure, a cable (not shown) that incorporates one or more optical fibers may be extended into the wellbore 116 within the drill pipe 108 (or another type of tubing or pipeline extendable within the wellbore 116) to obtain distributed and/or point measurements of one or more well parameters, such as fluid flow between the wellbore 116 and the surrounding formation 118. As used herein, “distributed optical fiber sensing” refers to the ability to obtain well parameter measurements along the entire length of an optical fiber, but also refers to the ability to obtain point measurements from point reflectors (e.g., Fiber Bragg Gratings, etc.) included at predetermined locations along the optical fiber(s).

Well systems sometimes use optical fibers as distributed acoustic sensors (DAS) and/or distributed temperature sensors (DTS). In such systems, a cable containing one or more optical fibers is deployed proximate a region of interest in the well, and the data obtained from the optical fiber(s) is used to determine various well parameters indicative of conditions or events occurring in the well. A number of distributed optical fiber sensing methodologies may be used to determine the well parameters of interest, without departing from the scope of the present disclosure. When electromagnetic radiation is transmitted through an optical fiber, a portion of the electromagnetic radiation will be backscattered in the optical fiber by impurities of the fiber, areas of different refractive index in the fiber generated in the process of fabricating the fiber, interactions with the surfaces of the optical fiber, and/or connections between the fiber and other optical fibers or components. Some of the backscattered electromagnetic radiation is treated as unwanted noise and steps may be taken to reduce such backscattering.

DAS is typically based on coherent Rayleigh scattering where an optical fiber is optically coupled with (i.e. in optical communication with) a narrow-band electromagnetic radiation source, such as a narrow-band laser or the like. The laser may be used to produce short pulses of light that are launched into the optical fiber and a fraction of the backward scattered light that falls within the angular acceptance cone of the optical fiber in the return direction, i.e., towards the laser source, may be guided back to the launching end of the fiber as a backscattered signal. The backscattered signal may be used to provide information regarding the time varying state of strain along the optical fiber, which may be equated to locations where fluctuations in acoustic (vibration) is occurring. A detector, such as an optoelectronic device may be in optical communication with the optical fiber and used to convert the backscattered electromagnetic signals to electrical signals, and a signal processor may process the electrical signals to determine the magnitude of the strain assumed by the optical fiber downstream of the detector.

DTS is typically based on distributed Raman scattering to detect changes in temperature along the optical fiber. More specifically, fluctuations or changes in temperature can affect the glass fibers of an optical fiber and locally change the characteristics of light propagation in the optical fiber. As a result of a temperature-dependent nonlinear process called Raman scattering, the location and magnitude of a temperature change can be determined so that the optical fiber can be used as a linear thermometer.

Two additional principles of measurement for distributed sensing technology are Optical Time Domain Reflectometry (OTDR) and Optical Frequency Domain Reflectometry (OFDR). OTDR detects and analyzes incoherent Rayleigh backscattering signals generated from narrow laser pulses generated by a laser, sent into the optical fiber. Based on the time it takes the backscattered light to return to an associated detector, it is possible to locate the location of a change in the characteristics of the optical fiber. OFDR provides information on the local characteristic only when the backscatter signal detected during the entire measurement time is measured as a function of frequency in a complex fashion, and then subjected to Fourier transformation. The essential principles of OFDR technology are the quasi continuous wave mode employed by the laser and the narrow-band detection of the optical backscatter signal.

While optical fibers are useful in measuring dynamic strain in undertaking DAS applications, optical fibers may also be used to measure static strain assumed by an optical fiber. More particularly, changes in the load on a wellbore cable that includes or otherwise incorporates an optical fiber may result in changes in the static strain assumed by the optical fiber. Static strain on wellbore cables is commonly measured at a rig site by monitoring the back tension on the wellbore cable. An optical fiber embedded within the wellbore cable, however, may also be able to measure the static strain as a function of the deformation assumed by the optical cable partly assuming the load. The amount of deformation in the optical cable may be proportional to the load applied to the cable and may be used, for example, in position correction.

Fluid flow and variations in the fluid flow between the wellbore 116 and the surrounding formation 118 during drilling operations, is one example of a well parameter that may be monitored using DAS or DTS, according to the presently described embodiments. As briefly mentioned above, measuring fluid flow between the wellbore 116 and the surrounding formation 118 during drilling operations may be accomplished by running a cable having one or more embedded optical fibers into the well within the drill pipe 138. Changes in strain and/or the temperature distribution profile along the optical fiber(s) may be used to infer and otherwise identify the axial location within the wellbore 116 of fluid flow between the wellbore 116 and the surrounding formation 118.

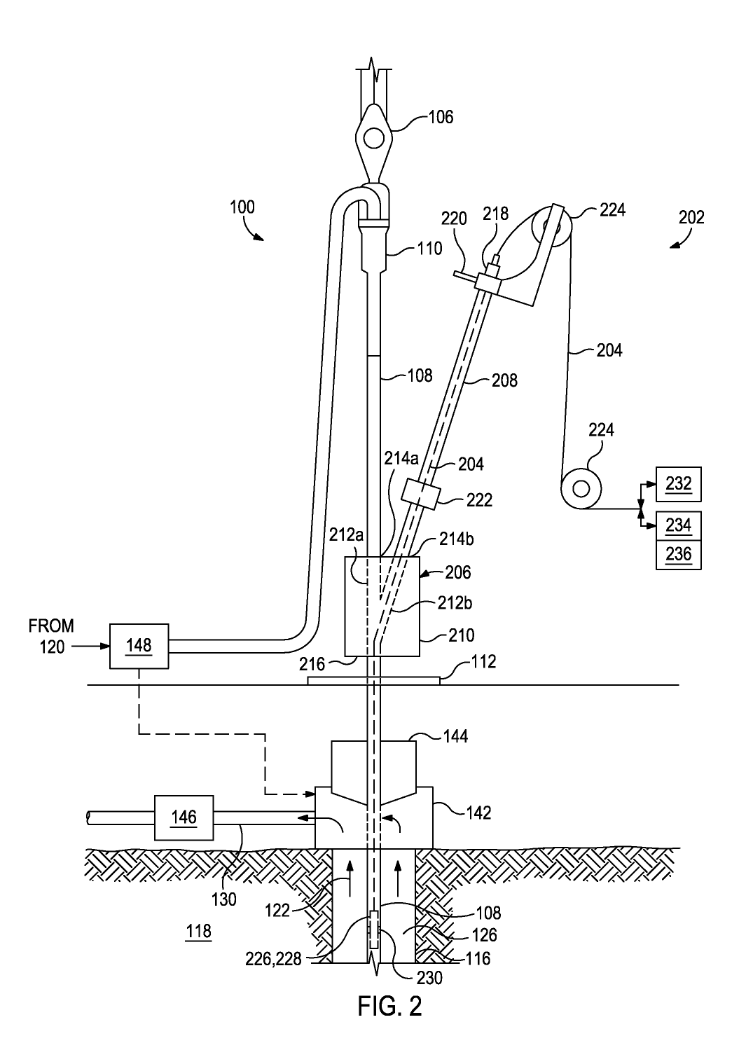

FIG. 2 is an enlarged view of a portion of the drilling system 100 of FIG. 1, according to one or more embodiments of the present disclosure. Similar numerals used in FIG. 1 that are used in FIG. 2 refer to like components or elements and, therefore, may not be described again in detail. According to the present disclosure, the drilling system 100 may further include a cable injection system 202 configured to inject and otherwise introduce a cable 204 into the drill pipe 108 as it is extended into the wellbore 116. It should be noted that the schematic diagram of the cable injection system 202 is used for illustrative purposes only in showing one way how the cable 204 may be introduced into the drill pipe 108. Those skilled in the art will readily recognize alternative configurations and/or designs that may be implemented in the cable injection system 202, without departing from the scope of the disclosure.

The cable 204 may comprise a variety of types, sizes, and/or designs, each of which containing one or more optical fibers included in the cable and otherwise embedded therein. In some embodiments, for example, the cable 204 may comprise a braided cable, such as what is commonly used in electric wireline tools, but containing an optical fiber. In such embodiments, the cable 204 may or may not include electrical conductors. In other embodiments, the cable 204 may comprise a composite slickline containing one or more optical fibers. In yet other embodiments, the cable 204 may comprise a hollow tube made of metal, plastic, or a composite and containing one or more optical fibers. It will be appreciated, however, that additional types or designs of the cable 204 incorporating optical fibers may alternatively be employed. Accordingly, the types of cable 204 suitable for the present application should not be limited to those specifically mentioned herein.

As illustrated, the cable injection system 202 may include a Y-block junction 206 and a lubricator 208 operatively coupled to the Y-block junction 206. The Y-block junction 206 may comprise a forged or formed pressure housing 210 made of metal. The Y-block junction 206 may provide and otherwise define a first conduit 212a and a second conduit 212b within the housing 210. The first and second conduits 212a,b may be either formed in the Y-block junction 206 during manufacture of the housing 210 or subsequently drilled into the housing 210 following manufacture. As illustrated, the first and second conduits 212a,b may converge at a point within the housing 210 such that fluid communication between the two conduits 212a,b is facilitated. Accordingly, one end of the housing 210 may provide two inlets 214a,b into the Y-block junction 206 corresponding to the first and second conduits 212a,b, respectively, but the opposing end of the housing 206 may provide a single outlet 216 from the Y-block junction 206.

The kelly 110 or a length of drill pipe 108 coupled to the kelly 110 may be coupled to the first conduit 212a at the first inlet 214a. For instance, in at least one embodiment, an intervening section of drill pipe 108, such as a short length commonly called a “pup joint,” may be positioned between the kelly 110 and the Y-block junction 206. The lubricator 208 may be coupled to the second conduit 212b at the second inlet 214b. In some embodiments, as illustrated, the lubricator 208 may be coupled to the housing 210 at an angle offset from vertical. In other embodiments, however, the lubricator 208 may be arranged substantially vertical with respect to the housing 210, without departing from the scope of the disclosure. The lubricator 208 may comprise an elongate, high-pressure pipe or tubular that provides a means for introducing the cable 204 into the drill pipe 108 via the Y-block junction 206. The top of the lubricator 208 may include a stuffing box 218 fluidly coupled to a high-pressure grease-injection line 220 used to introduce grease or another type of sealant into the stuffing box 218 in order to generate a seal. The lower part of the lubricator 208 may include one or more valves 222, such as an isolating valve or swab valve.

The cable 204 is generally fed to the lubricator 208 from a spool or drum (not shown) and through one or more sheaves 224 (two shown) before being introduced into the stuffing box 218 which provides a seal about the cable 204 as it slides or otherwise advances into the lubricator 208. From the stuffing box 218, the cable 204 may be extended into the lubricator 208 and conveyed into the Y-block junction 206 via the second conduit 212b. After converging with the first conduit 212a, the cable 204 may exit the Y-block junction 206 via the outlet 216, which may be coupled to the string of drill pipe 108 extending into the wellbore 116 through the wellhead 142.

In some embodiments, a sinker bar 226 may be attached to the end of the cable 204. For vertical portions of the wellbore 116, the sinker bar 226 may be used to help pull the cable 204 further downhole under the force of gravity. For horizontal portions of the wellbore 116, however, the sinker bar 226 may be replaced with a wiper plug 228 that provides one or more wipers 230 extending radially outward and toward the inner wall of the drill pipe 108. The wipers 230 may allow fluid pressure to build up behind the wiper plug 128 to propel the cable 204 further downhole. The pressure differential across the wiper plug 228 may generate the propulsion forces required to pull the cable 204 down the well within the drill pipe 108 and across horizontal sections of the wellbore 116.

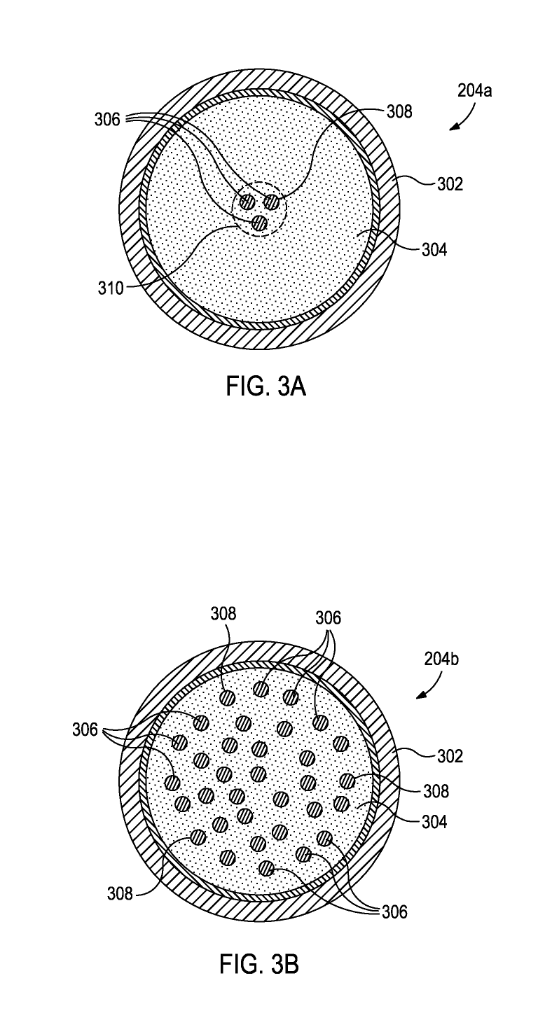

Referring now to FIGS. 3A and 3B, illustrated are cross-sectional end views of two exemplary cables 204, according to embodiments of the present disclosure. More particularly, FIG. 3A depicts a cross-sectional end view of a first cable 204a and FIG. 3B depicts a cross-sectional end view of a second cable 204b. Each cable 204a, 204b may be similar to or the same as the cable 204 of FIG. 2 and, therefore, may each be conveyed into the wellbore 116 via the drill pipe 108, as generally described above. Moreover, the cables 204a,b depicted in FIGS. 3A and 3B may each be characterized as a slickline made at least partially from composite materials and may otherwise be referred to as “composite slicklines.”

As illustrated in FIG. 3A, the first cable 204a includes a sheath 302 disposed about a polymer composite 304. The sheath 302 acts as a protective coating for the polymer composite 304 to mitigate damage to the polymer composite 304 or components thereof during operation. In some instances, however, the sheath 302 may be excluded from the cable 204a.

The sheath 302 may be made of a metal material or another polymer with better performance with respect to properties including anti-wearing, hermetical sealing, and high mechanical strength. Non-limiting examples of metal materials suitable for use as the sheath 302 may include stainless steel, aluminum, copper, and their alloy compositions. Non-limiting examples of polymers suitable for use as the sheath 302 may include polyolefins, polytetrafluoroethylene-perfluoromethylvinylether polymer (PTFE-MFA), perfluoro-alkoxyalkane polymer (PFA), polytetrafluoroethylene polymers (PTFE, i.e., TEFLON®), ethylene-tetrafluoroethylene polymers (ETFE), ethylene-propylene copolymers (EPC), polysulfone (PSF), polyethersulfone (PES), polyarylether ketone polymers (PAEK), polyetherether ketone (PEEK), polyphenylene sulfide polymers (PPS), modified polyphenylene sulfide polymers, polyether ketone polymers (PEK), maleic anhydride modified polymers, perfluoroalkoxy polymers, fluorinated ethylene propylene polymers, polyvinylidene fluoride polymers (PVDF), polytetrafluoroethylene-perfluoromethylvinylether polymers, polyamide polymers, polyimide polymers, polyurethane, thermoplastic polyurethane, ethylene chloro-trifluoroethylene polymers, chlorinated ethylene propylene polymers, self-reinforcing polymers based on a substituted poly(1,4-phenylene) structure where each phenylene ring has a substituent R group derived from a wide variety of organic groups, and the like, and any combination thereof.

In some instances, the aforementioned polymers alone may not have sufficient mechanical strength and wearing properties to withstand high pull or compressive forces as the cable 204a is pulled, for example, through the stuffing box 218 (FIG. 2) while being run downhole. As such, the polymer material of the sheath 302 may, in some embodiments, further include reinforced continuous or non-continuous fibers to increase mechanical strength and wearing properties. While any suitable fibers may be used to provide mechanical strength properties sufficient to withstand such forces, exemplary fibers include, but are not limited to, carbon fibers, fiberglass, ceramic fibers, aramid fibers, metallic filaments, liquid crystal aromatic polymer fibers, quartz, carbon nanotubes, and the like, and any combination thereof. Metallic fibers and filaments may, in some instances, be composed of materials such as iron, aluminum, cobalt, nickel, tungsten, and the like, and any combination thereof.

The polymer composite 304 may comprise a polymer matrix with a plurality of fibers embedded therein to provide desirable mechanical strength. Non-limiting examples of materials suitable for use as the polymer matrix of the polymer composite 304 may include thermoplastic or thermoset resins including polyolefins, PTFE-MFA, PFA, PTFE, ETFE, EPC, poly(4-methyl-1-pentene), other fluoropolymers, PSF, PES, PAEK, PEEK, PPS, modified polyphenylene sulfide polymers, PEK, maleic anhydride modified polymers, perfluoroalkoxy polymers, fluorinated ethylene propylene polymers, PVDF, polytetrafluoroethylene-perfluoromethylvinylether polymers, polyamide polymers, polyurethane, thermoplastic polyurethane, ethylene chloro-trifluoroethylene polymers, chlorinated ethylene propylene polymers, self-reinforcing polymers based on a substituted poly(1,4-phenylene) structure where each phenylene ring has a substituent R group derived from a wide variety of organic groups, and the like, and any combination thereof. In one embodiment, the preferred polymer material has high percentage of crystalline structure. In another embodiment, the preferred polymer material has high glass transition temperature. In the other embodiment, the preferred polymer material has high melting point temperature.

Non-limiting examples of continuous or non-continuous fibers suitable for use in the polymer composite 304 may include carbon fibers, silicon carbide fibers, aramid fibers, glass fibers, ceramic fiber, metal filaments, carbon nanotubes, and the like, and any combination thereof. In one embodiment, these fibers may have a length ranging from few millimeters to a few meters. In another embodiment, these fibers may be from a few meters to a few hundred meters. Metallic fibers and filaments may, in some instances, be composed of materials such as iron, aluminum, cobalt, nickel, tungsten, and the like, and any combination thereof. These materials are dispersed uniformly inside the polymer matrix.

The cable 204a may further include one or more optical fibers 306 (three shown) embedded within the polymer composite 304 and extending along all or a portion of the length of the cable 204a. The optical fibers 306 may be useful for obtaining distributed acoustic (i.e., vibration, seismic, etc.) and/or temperature measurements along the length of the optical fibers 306. In some embodiments, one or more of the optical fibers 306 may also be used to facilitate communicating between the BHA 136 (FIG. 1) and a surface location.

The optical fibers 306 may be low-transmission loss optical fibers that are either single-mode or multi-mode and exhibit a transmission bandwidth from about 600 nm to about 2200 nm with its lowest loss bandwidth ranging from about 150 nm to about 1550 nm. In at least one embodiment, one or more of the optical fibers 306 may exhibit a gradient refractive index (i.e., graded index) across its fiber core to ensure light transmission is strongly guided by the fiber core path that may ensure bending insensitivity and low transmission loss.

In some instances, the optical fibers 306 may have a coating or a cladding 308 disposed thereon or otherwise encapsulating the optical fibers 306. The cladding 308 may be a high-temperature coating made of, for example, a thermoplastic material, a thermoset material, a metal, an oxide, carbon fiber, or any combination thereof. In other embodiments, the cladding 308 may be a single-layer carbon coating, or a carbon and polyimide dual-layer coating. The cladding 308 may prove useful for a variety of purposes. For instance, the cladding 308 may improve the mechanical bonding strength of the optical fibers 306 to the polymer composite 304. The cladding 308 may also help reduce thermal expansion mismatch between the optical fibers 306 and the materials of the polymer composite 304, and thereby effectively transfer axial loads to the fibers embedded within the polymer composite 304. The cladding 308 may further provide a hermetic seal that protects the optical fibers 306 from moisture and/or hydrogen that might induce artificial signal attenuation by hydroxyl ion or molecular hydrogen absorption.

In other embodiments, the optical fibers 306 may each be sealed and otherwise loosely housed within a hollow or “loose” tube 310 positioned at or near the centerline of the cable 204a and otherwise embedded within the polymer composite 304. The loose tube 310 provides an elongated housing for the optical fibers 306 but also isolates the optical fibers 306 from tensile stresses or strains that may be assumed by the polymer composite 304 during downhole deployment and operation. As a result, the optical fibers 306 are able to avoid signal attenuation and data infidelity during tension loading of the cable 204a that might otherwise damage or sever the optical fibers 306. As will be appreciated, the loose tube 310 may also prove advantageous in providing strain-free protection to an optical fiber 306 for high fidelity data transmission.

The second cable 204b of FIG. 3B may be similar in some respects to the first cable 204a and therefore may be best understood with reference thereto, where like numerals represent like elements not described again. For instance, the second cable 204b may also include the sheath 302, the polymer composite 304, and one or more optical fibers 306 positioned within the polymer composite 304. Unlike the first cable 204a, however, second cable 204b may include several more than three optical fibers 306, which may be arranged in a random pattern as embedded within the polymer composite 304.

In some embodiments, one or more of the optical fibers 306 of either cable 204a,b may comprise a multi-mode optical fiber used for distributed acoustic sensing along the wellbore 116 (FIG. 2) within the drill pipe 108 (FIG. 2). One or more second optical fibers 306 in either cable 204a,b may also comprise a multi-mode optical fiber but may alternatively be used for distributed temperature sensing along the wellbore 116 within the drill pipe 108 (FIG. 2). In at least one embodiment, one or more third optical fibers 306 in either cable 204a,b may comprise a single-mode optical fiber used for telemetry purposes in communicating signals between the BHA 136 (FIG. 1) and a surface location.

Referring again to FIG. 2, running the cable 204 into the wellbore 116 during drilling operations, as will be appreciated, may require wellbore pressure control while rigging up (i.e., installing) the cable injection system 202, while running the cable 204 into the drill pipe 108, and while rigging down (i.e., disassembling) the cable injection system 202. To accomplish this, the rig pump diverter 148 may be activated and otherwise used to direct the flow of the drilling fluid 122 from the rig pumps 120 (FIG. 1) directly to the annulus 126 to maintain circulation. While flow is directed back to the annulus 126, the cable injection system 202 may be installed and/or disassembled along the length of the string of drill pipes 108 in the drilling system 100. Accordingly, the presently described embodiments may maintain drilling fluid 122 circulation, which may be required for managed pressure drilling and/or underbalanced pressure drilling operations.

The cable 204 may be introduced downhole within the drill pipe 108 to obtain distributed optical fiber measurements while circulating the drilling fluid 122. In order to pump the cable 204 down the drill pipe 108, flow can be re-diverted back to the kelly 110 and through the first conduit 212a after installing the cable injection system 202. The cable 204 may be conveyed down the drill pipe 108 to at or near the drill bit 114 (FIG. 1) and measurements may then be obtained via the optical fibers 306 (FIGS. 3A and 3B) embedded therein to determine where fluids are entering and/or leaving the wellbore 116 along the length of the drilled wellbore 116. For a substantially vertical well, as indicated above, the sinker bar 226 may be used to pull the cable 204 into the well under gravitational force. For wells with horizontal sections, however, the sinker bar 226 may be replaced with the wiper plug 228 used to generate a pressure differential sufficient to pump the cable 204 downhole and across horizontal portions.

Advantageously, circulation of the drilling fluid 122 within the wellbore 116 may be continuous while running the cable 204 downhole within the drill pipe 108. When using the sinker bar 226, for instance, the outer diameter of the sinker bar 226 may be smaller than the inner diameter of the drill pipe 108. As a result, ample flow area may be provided around the cable 204 and the sinker bar 226 that allows continuous circulation of the drilling fluid 122 through the wellbore 116. Similarly, when using the wiper plug 228 to pull (propel) the cable 204 into the drill pipe 108, the outer diameter of the wipers 230 may not extend all the way to the inner diameter of the drill pipe 108. As a result, flow paths or flow area may again be provided around the wiper plug 228 that allows continuous circulation of the drilling fluid 122 through the wellbore 116.

In some embodiments, however, the wipers 230 may be configured to extend to the inner wall of the drill pipe 108. In such embodiments, the wiper plug 228 may be configured to land on a slotted shoulder (not shown) or the like located within the drill pipe at a known location. The wipers 230 may be flexible and therefore able to bend forward (i.e., toward the bottom of the wellbore 116) in response to the fluid pressure built up behind the wiper plug 228. Bending the wipers 230 forward may allow fluid flow around the wiper plug 228 in the downhole direction and thereby maintain circulation throughout the wellbore 116 at a desired flow rate. Alternatively, if the cable 204 has sufficient strength to overcome the differential forces across the wiper plug 228, an operator may decide to maintain tension in the cable 204 to stop downhole travel of the wiper plug 228. Once stopped within the drill pipe 108, the wipers 230 may be forced to flex forward, and thereby allow fluid flow to bypass the wiper plug 228 without requiring the wiper plug 228 to land on a seat or other feature provided in the drill string 108.

With the cable 204 extended within the drill pipe 108, measurements along the length cable 204 or at selected points may then be obtained to determine one or more well parameters. The optical fiber(s) 306 (FIGS. 3A and 3B) embedded within the cable 204 may be in optical communication at the surface with an electromagnetic radiation source 232 and a data acquisition system 234. The electromagnetic radiation source 232 may be configured to emit and otherwise introduce electromagnetic radiation into the optical fiber(s) 306. The electromagnetic radiation source 232 may include, but is not limited to, ambient light, a light bulb, a light emitting diode (LED), a laser, a blackbody radiator source, a supercontinuum source, combinations thereof, or the like. Accordingly, the electromagnetic radiation may include, but is not limited to, terahertz, infrared and near-infrared radiation, visible light, and ultraviolet light.

The data acquisition system 234 may include one or more detectors 236 positioned to sense and otherwise monitor the intensity of the returning backscattered electromagnetic radiation for analysis. The detector 236 may be an optical transducer. The detector 236 may comprise, but is not limited to, a thermal detector (e.g., a thermopile or photoacoustic detector), a semiconductor detector, a piezo-electric detector, a charge coupled device (CCD) detector, a photodetector, a video or array detector, a split detector, a photon counter detector (such as a photomultiplier tube), any combination thereof, or any other detectors known to those skilled in the art. The data acquisition system 234 may further include a signal processor or signal analysis equipment associated with the detector 236, which may include a standard optical spectral analyzer having a processor for processing, storing in memory, and displaying to a user the detected results. The signal analysis equipment is capable of converting the received signals into an electronic signal, such as a high-speed linear photodetector array, a CCD array, or a CMOS array. In some embodiments, the processor may be provided with a user interface for input and control, such as by generating reports and performing fast Fourier transform analyses. In at least one embodiment, the data acquisition system 234 may be configured to provide noise (acoustic) and temperature logs of the entire length of the wellbore 116 so that a well operator can analyze the presence and location of flows between the formation 118 and the wellbore 116.

The backscattered electromagnetic radiation measured by the detector 236 may be correlated to strain (dynamic and static) and temperature profiles sensed by the cable 204, which may be indicative of fluid flow between the surrounding formation 118 and the wellbore 116. Since the speed of light is, at first approximation, constant along optical fibers, the distance from the surface to the point where the backscatter originated can also be readily determined when the effective refractive index of the combined fiber core and cladding is known (e.g., about 1.468 at 1550 nm). Accordingly, backscatter generated within the optical fiber(s) 306 (FIGS. 3A and 3B) as measured by the detector 236 may indicate the axial position of fluid flow between the surrounding formation 118 and the wellbore 116. After a few seconds or minutes of data gathering, noise and/or temperature logs of the entire wellbore 116 can be generated by the data acquisition system 234 and subsequently analyzed to determine the presence and location of flows between the formation 118 and the wellbore 116. For increased accuracy of the location of the flows sensed by this approach, the temperature profile (determined by DTS), can be used to calculate a position correction due to the temperature dependence of the index of refraction (thermo-optic effects) and cable length (thermo-elastic effects). Furthermore, a measurement of cable tension (at the surface) or the static strain profile along the optical fiber (using Brillouin or Optical Frequency Domain Reflectometry) can be used to take into account the strain in the optical fiber on the cable length.

In some embodiments, it may be desired to determine what locations within the drilled wellbore 116 may be viable hydrocarbon producing regions. More particularly, and assuming no fluid losses or influxes between the formation 118 and the wellbore 116 are detected through the above-described measurements, it may be possible to locate and/or clean up the productive regions of the wellbore 116 prior to retrieving the string of drill pipe 108 from the wellbore 116. To accomplish this, the choke manifold 146 may be manipulated to decrease the equivalent circulation density (ECD) of the drilling fluid 122 within the wellbore 116. As known in the art, the ECD is a function of fluid density, flow rate, and choke settings of the choke manifold 146. Accordingly, by decreasing the ECD of the drilling fluid 122, the pressure within the wellbore 116 will simultaneously decrease, and may decrease to a point below the formation 118 pressure. Once the wellbore 116 pressure dips below the formation 118 pressure, the cable 204 may be able to detect fluid flow from the formation 118 into the wellbore 116 from distributed noise and/or temperature optical fiber measurements. Locations where fluid is determined to flow into the wellbore 116 may be indicative of where the well may produce hydrocarbons during production.

In other embodiments, it may be desired to determine what locations within the drilled wellbore 116 are more prone to fracturing and, therefore more prone to lost circulation. More particularly, and again assuming no fluid losses or influxes between the formation 118 and the wellbore 116 are present, it may be possible to locate which regions of the wellbore 116 exhibit the lowest fracture pressure gradient prior to retrieving the string of drill pipe 108 from the wellbore 116. To accomplish this, the choke manifold 146 may be manipulated to increase the equivalent circulation density (ECD) of the drilling fluid 122 within the wellbore 116. By increasing the ECD of the drilling fluid 122, the pressure within the wellbore 116 will simultaneously increase, and may increase to a point above the fracture pressure gradient of the formation 118. Once the wellbore 116 pressure exceeds the formation 118 pressure, the cable 204 may be able to detect fluid flow from the wellbore 116 into the formation 118 from distributed noise and/or temperature optical fiber measurements. Locations where fluid flows into the formation 118 may be an indication of what regions of the well are more prone to fracturing.

After the desired well parameters are obtained, the cable 204 may be returned to the surface and reeled back through the lubricator 208. The cable injection system 202 may then be disassembled from the drilling system 100 and the wellbore 116 may then continue to be drilled without the Y-block junction 206 arranged in the string of drill pipe 108. As will be appreciated, using the cable 204 as described herein may greatly enhance managed pressure drilling and underbalanced drilling operations. The optical fiber(s) 306 (FIGS. 3A and 3B) embedded within the cable 204 may facilitate monitoring of sound (noise) and/or temperature over the full length of the wellbore 116 using distributed acoustic sensing (DAS) and distributed temperature sensing (DTS).

In some embodiments, one or more of the optical fibers 306 (FIGS. 3A-3B) of the cable may be configured as point reflectors (alternately referred to as point sensors). Point reflectors may comprise Fiber Bragg Gratings positioned at known locations along the length of the optical fiber 306 and may be advantageous in obtaining localized sound and/or temperature measurements. Point reflectors may be used in both DAS and DTS systems, and Fiber Bragg Gratings are not reliant on coherent Rayleigh.

In some embodiments, a fiber-based pressure sensor or gauge may be positioned at or near the end of one or more of the optical fibers 306 (FIGS. 3A-3B) or at an intermediate known location along the length of the optical fiber 306. The fiber-based pressure sensor may comprise a point sensor, such as a Fiber Bragg Grating, but may be configured to measure and otherwise sense pressure. Accordingly, in place of using an electrically-powered pressure gauge, embodiments of the present disclosure include the use of all optical pressure gauge.

In some embodiments, as briefly mentioned above, one or more of the optical fibers 306 (FIGS. 3A-3B) within the cable 204 may be used to transmit data derived from the BHA 136 (FIG. 1) to the data acquisition system 234 for processing. More particularly, in at least one embodiment, the BHA 136 may include an acoustic transmitter used to transmit acoustic signals that may be detected by one or more of the optical fibers 306. In some embodiments, a sensitive microphone or pressure transducer may be coupled to the optical fiber 306 to receive the transmitted acoustic signals and convert the acoustic signals into signals to be conveyed by the optical fiber 306. The acoustic signals may represent measurement data obtained by the various sensor modules 138 (FIG. 1) of the BHA 136 including, but not limited to, the formation evaluation sensors, directional sensors, an MWD tool, a LWD tool, a PWD tool, and any other known downhole sensor. Accordingly, embodiments of the present disclosure also contemplate downloading data from the BHA 136 during drilling operations and transmitting the data in real-time to the surface via the cable.

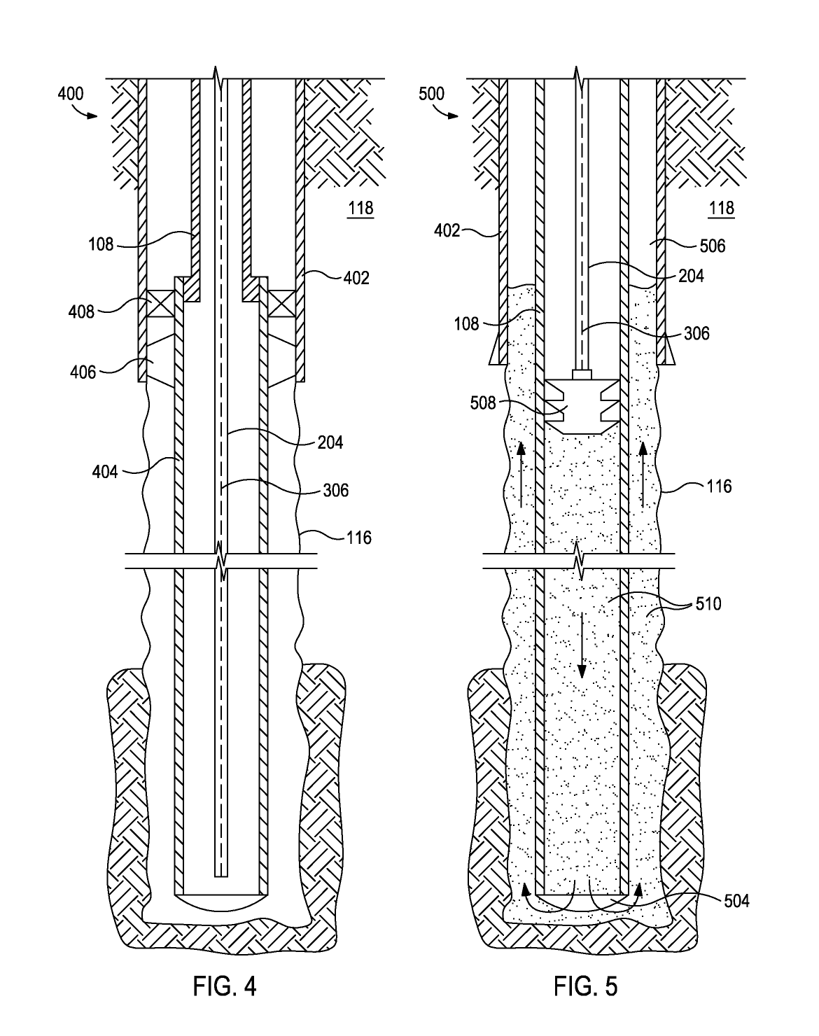

Referring to FIG. 4, illustrated is a cross-sectional view of an exemplary well system 400 that may employ the principles of the present disclosure, according to one or more embodiments. In some embodiments, the well system 400 may form part of the drilling system 100 of FIGS. 1-2 and, therefore, the well system 400 may be best understood with reference to FIGS. 1-2, where like numerals represent like elements not described again in detail. As illustrated, the drill pipe 108 is extended into the wellbore 116 penetrating the subterranean formations 118.

In the illustrated embodiment, a portion of the wellbore 116 may be lined with casing 402. As used herein, the term “casing” refers to a plurality of tubular pipe lengths extendable into the wellbore 116 and coupled (e.g., threaded) together to form a continuous tubular conduit of a desired length. It will be appreciated, however, that the casing 402 may equally refer to a single tubular length or structure, without departing from the scope of the disclosure.

The drill pipe 108 may be used as a conveyance to convey and otherwise introduce a smaller diameter wellbore-lining tubing known as a wellbore liner 404 into the wellbore 116. Accordingly, in such embodiments, the drill pipe 108 may be characterized as a liner running string. Once advanced to a desired location within the wellbore 116, the wellbore liner 404 may be “hung off” and otherwise secured to the casing 402 by means of a liner hanger 406. As illustrated, the wellbore liner 404 may extend from the distal end of the casing 402 to the toe of the wellbore 116. A sealing device or wellbore packer 408 can then be operated to seal the upper end of the wellbore liner 404 against the inner wall of the casing 402. The drill pipe 108 and the wellbore liner 404 cooperatively provides a pathway for the passage of fluids (e.g., cement, drilling fluid, spacers, cleaning fluids, acids, etc.). to the bottom of the wellbore 116.

The cable 204 may be extended through the drill pipe 108 and into all or a portion of the wellbore liner 404, and thereby extending the one or more optical fibers 306 along all or a portion of the length of the wellbore 116. With the cable 204 extended within the drill pipe 108 and the wellbore liner 404, measurements along the length cable 204 or at selected points within the wellbore 116 may then be obtained to determine one or more well parameters, such as the presence and location of flows between the formation 118 and the wellbore 116 or flows behind the casing 402.

Referring to FIG. 5, illustrated is a cross-sectional view of another exemplary well system 500 that may employ the principles of the present disclosure, according to one or more embodiments. Similar to the well system 400 of FIG. 4, the well system 500 may also form part of the drilling system 100 of FIGS. 1-2 and, therefore, may be best understood with reference to FIGS. 1-2, where like numerals represent like elements not described again in detail. Moreover, a portion of the wellbore 116 may be lined with the casing 402, as described above.

In the illustrated embodiment, the drill pipe 108 may be used in a cementing operation. A shoe 504 may be attached at the bottom-most portion of the drill pipe 108, and an annulus 506 is defined between the wellbore 116 and the drill pipe 108. A wiper plug 508 is shown being pumped or otherwise conveyed through the drill pipe 108 toward the shoe 504 and simultaneously displacing cement 510 out of the drill pipe 108 at the shoe 504. From the shoe 504, the cement 510 flows back toward the earth's surface within the annulus 506.

In some embodiments, the cable 204 may be attached to a top of the wiper plug 508 and thereby conveyed through the drill pipe 108 and otherwise into the wellbore 116 simultaneously with the wiper plug 508. As a result, the one or more optical fibers 306 may also be conveyed along all or a portion of the length of the wellbore 116. With the cable 204 extended within the drill pipe 108 and the wellbore liner 404, measurements along the length cable 204 or at selected points within the wellbore 116 may then be obtained to determine one or more well parameters, such as the presence and location of flows between the formation 118 and the wellbore 116. In some embodiments, for instance, distributed acoustic or temperature measurements may be made using the optical fibers 306 to detect fluid flow behind the casing 402, which may be indicative of a faulty completion or setting of the casing 402 within the wellbore 116. In other embodiments, distributed acoustic or temperature measurements may be made using the optical fibers 306 to monitor the progress of the cementing job. For instance, as the cement 510 cures, the temperature within the wellbore 116 may increase, and such temperature increases can be monitored in real-time using the cable 204. In yet other embodiments, the distributed acoustic or temperature measurements may be made to monitor flow and thereby determine if cement 510 is being lost into vugs, cracks, or fractures defined in the walls of the wellbore 116.

Embodiments disclosed herein include:

A. A drilling system that includes a string of drill pipe extending into a wellbore from a drilling platform, a Y-block junction coupled to the string of drill pipe at the drilling platform and providing a pressure housing that defines a first conduit and a second conduit that converges with the first conduit, the pressure housing further defining an outlet configured to be coupled to the string of drill pipe extending into the wellbore, a lubricator operatively coupled to the Y-block junction at the second conduit, and a cable including one or more optical fibers and being conveyable into the wellbore within the string of drill pipe via the lubricator and the Y-block junction.

B. A method that includes extending a string of drill pipe into a wellbore from a drilling platform, coupling a Y-block junction to the string of drill pipe at the drilling platform, the Y-block junction providing a pressure housing that defines a first conduit and a second conduit that converges with the first conduit, coupling the string of drill pipe to an outlet defined in the pressure housing, coupling a lubricator to the Y-block junction at the second conduit, conveying a cable including one or more optical fibers into the wellbore within the string of drill pipe via the lubricator and the Y-block junction, and sensing one or more well parameters with the one or more optical fibers.

Each of embodiments A and B may have one or more of the following additional elements in any combination: Element 1: wherein the cable comprises a composite slickline that includes a polymer composite having the one or more optical fibers positioned therein, and a sheath disposed about the polymer composite and being made of a metal or a polymer. Element 2: wherein the one or more optical fibers are used for at least one of distributed acoustic sensing, distributed temperature sensing, and static strain sensing along all or a portion of the wellbore within the string of drill pipe. Element 3: further comprising a bottom hole assembly coupled to the string of drill pipe and including one or more sensor modules, wherein at least one of the one or more optical fibers communicates with the one or more sensor modules to transmit measurement data obtained by the one or more sensor modules to a surface location. Element 4: further comprising an electromagnetic radiation source in optical communication with the one or more optical fibers to emit electromagnetic radiation into the one or more optical fibers, and a data acquisition system in optical communication with the one or more optical fibers and including one or more detectors and a signal processor. Element 5: wherein at least one of the one or more optical fibers includes a Fiber Bragg Grating positioned at known location along a length of the at least one of the one or more optical fibers. Element 6: further comprising a wellbore liner attached to a distal end of the string of drill pipe, wherein the cable is conveyable into the wellbore within the string of drill pipe and the wellbore liner.

Element 7: wherein coupling the Y-block junction to the string of drill pipe comprises diverting a flow of drilling fluid with a rig pump diverter to an annulus defined between the string of drill pipe and the wellbore, and conveying the flow of the drilling fluid back to the string of drill pipe via the first conduit once the Y-block junction is coupled to the string of drill pipe and the lubricator is coupled to the Y-block junction. Element 8: further comprising returning the cable to the lubricator, diverting the flow of the drilling fluid with the rig pump diverter to the annulus defined between the string of drill pipe and the wellbore, removing the lubricator from the Y-block junction, removing the Y-block junction from the string of drill pipe, and conveying the flow of the drilling fluid back to the string of drill pipe. Element 9: wherein a sinker bar is attached to a distal end of the cable and conveying the cable into the wellbore within the string of drill pipe comprises pulling the cable into the well under gravitational forces provided by the sinker bar.

Element 10: wherein a wiper plug is attached to a distal end of the cable and conveying the cable into the wellbore within the string of drill pipe comprises pumping the cable into the well by building up fluid pressure behind the wiper plug. Element 11: further comprising continuously circulating a drilling fluid through the string of drill pipe while conveying the cable into the wellbore within the string of drill pipe. Element 12: further comprising obtaining at least one of distributed acoustic, distributed temperature, and static strain measurements along the wellbore within the string of drill pipe with at least one of the one or more optical fibers. Element 13: wherein a bottom hole assembly is coupled to the string of drill pipe and includes one or more sensor modules, the method further comprising communicating measurement data from the one or more sensor modules to at least one of the one or more optical fibers, and transmitting the measurement data obtained by the one or more sensor modules to a surface location with the at least one of the one or more optical fibers. Element 14: further comprising decreasing an equivalent circulation density of a drilling fluid circulating within the wellbore until a pressure within the wellbore decreases below a pressure of a subterranean formation penetrated by the wellbore, and sensing at least one of noise and a temperature fluctuation within the wellbore with the one or more optical fibers, wherein the at least one of the noise and the temperature fluctuation is indicative of fluid flow from the subterranean formation into the wellbore. Element 15: further comprising regulating a bottom hole pressure at a location of the fluid flow from the subterranean formation into the wellbore with a choke manifold in fluid communication with the annulus defined between the string of drill pipe and the wellbore. Element 16: further comprising increasing an equivalent circulation density of a drilling fluid circulating within the wellbore until a pressure within the wellbore increases above a fracture pressure gradient of a subterranean formation penetrated by the wellbore, and sensing at least one of noise and a temperature fluctuation within the wellbore with the one or more optical fibers, wherein the at least one of the noise and the temperature fluctuation is indicative of fluid flow from the wellbore into the subterranean formation. Element 17: further comprising regulating a bottom hole pressure at a location of the fluid flow from the wellbore into the subterranean formation with a choke manifold in fluid communication with the annulus defined between the string of drill pipe and the wellbore. Element 18: wherein at least one of the one or more optical fibers includes a Fiber Bragg Grating positioned at known location along a length of the at least one of the one or more optical fibers, the method further comprising obtaining at least one of localized noise and temperature measurements with the Fiber Bragg Grating. Element 19: wherein a wellbore liner is coupled to a distal end of the string of drill pipe, the method further comprising conveying the cable into the wellbore within the string of drill pipe and the wellbore liner, and obtaining at least one of distributed acoustic, distributed temperature, and static strain measurements along the wellbore within the string of drill pipe and the wellbore liner with at least one of the one or more optical fibers. Element 20: wherein at least a portion of the wellbore is lined with casing, and wherein sensing the one or more well parameters with the one or more optical fibers comprises obtaining at least one of distributed acoustic and temperature measurements with at least one of the one or more optical fibers and thereby detecting fluid flow behind the casing. Element 21: wherein the cable is coupled to a wiper plug disposed within the string of drill pipe, the method further comprising pumping the wiper plug through the string of drill pipe and thereby displacing cement out a distal end of the string of drill pipe and into an annulus defined between the wellbore and the string of drill pipe, and obtaining at least one of distributed acoustic and temperature measurements with at least one of the one or more optical fibers and thereby monitoring a progress of the cement within the annulus.

By way of non-limiting example, exemplary combinations applicable to A and B include: Element 7 with Element 8; Element 14 with Element 15; and Element 16 with Element 17.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

1. A drilling system, comprising:
a string of drill pipe extending into a wellbore from a drilling platform;
a Y-block junction coupled to the string of drill pipe at the drilling platform and providing a pressure housing that defines a first conduit and a second conduit that converges with the first conduit, the pressure housing further defining an outlet configured to be coupled to the string of drill pipe extending into the wellbore;
a lubricator operatively coupled to the Y-block junction at the second conduit; and
a cable including one or more optical fibers and being conveyable into the wellbore within the string of drill pipe via the lubricator and the Y-block junction.

2. The drilling system of claim 1, wherein the cable comprises a composite slickline that includes:
a polymer composite having the one or more optical fibers positioned therein; and
a sheath disposed about the polymer composite and being made of a metal or a polymer.

3. (canceled)

4. The drilling system of claim 1, further comprising a bottom hole assembly coupled to the string of drill pipe and including one or more sensor modules, wherein at least one of the one or more optical fibers communicates with the one or more sensor modules to transmit measurement data obtained by the one or more sensor modules to a surface location.

5. The drilling system of claim 1, further comprising:
an electromagnetic radiation source in optical communication with the one or more optical fibers to emit electromagnetic radiation into the one or more optical fibers; and
a data acquisition system in optical communication with the one or more optical fibers and including one or more detectors and a signal processor.

6. (canceled)

7. (canceled)

8. A method, comprising:
extending a string of drill pipe into a wellbore from a drilling platform;
coupling a Y-block junction to the string of drill pipe at the drilling platform, the Y-block junction providing a pressure housing that defines a first conduit and a second conduit that converges with the first conduit;
coupling the string of drill pipe to an outlet defined in the pressure housing;
coupling a lubricator to the Y-block junction at the second conduit;
conveying a cable including one or more optical fibers into the wellbore within the string of drill pipe via the lubricator and the Y-block junction; and
sensing one or more well parameters with the one or more optical fibers.

9. The method of claim 8, wherein coupling the Y-block junction to the string of drill pipe comprises:
diverting a flow of drilling fluid with a rig pump diverter to an annulus defined between the string of drill pipe and the wellbore; and
conveying the flow of the drilling fluid back to the string of drill pipe via the first conduit once the Y-block junction is coupled to the string of drill pipe and the lubricator is coupled to the Y-block junction.

10. The method of claim 9, further comprising:
returning the cable to the lubricator;
diverting the flow of the drilling fluid with the rig pump diverter to the annulus defined between the string of drill pipe and the wellbore;
removing the lubricator from the Y-block junction;
removing the Y-block junction from the string of drill pipe; and
conveying the flow of the drilling fluid back to the string of drill pipe.

11. The method of claim 8, wherein a sinker bar is attached to a distal end of the cable and conveying the cable into the wellbore within the string of drill pipe comprises pulling the cable into the well under gravitational forces provided by the sinker bar.

12. The method of claim 8, wherein a wiper plug is attached to a distal end of the cable and conveying the cable into the wellbore within the string of drill pipe comprises pumping the cable into the well by building up fluid pressure behind the wiper plug.

13. The method of claim 8, further comprising continuously circulating a drilling fluid through the string of drill pipe while conveying the cable into the wellbore within the string of drill pipe.

14. The method of claim 8, further comprising obtaining at least one of distributed acoustic, distributed temperature, and static strain measurements along the wellbore within the string of drill pipe with at least one of the one or more optical fibers.

15. The method of claim 8, wherein a bottom hole assembly is coupled to the string of drill pipe and includes one or more sensor modules, the method further comprising:
communicating measurement data from the one or more sensor modules to at least one of the one or more optical fibers; and
transmitting the measurement data obtained by the one or more sensor modules to a surface location with the at least one of the one or more optical fibers.

16. The method of claim 8, further comprising:
decreasing an equivalent circulation density of a drilling fluid circulating within the wellbore until a pressure within the wellbore decreases below a pressure of a subterranean formation penetrated by the wellbore; and
sensing at least one of noise and a temperature fluctuation within the wellbore with the one or more optical fibers, wherein the at least one of the noise and the temperature fluctuation is indicative of fluid flow from the subterranean formation into the wellbore.

17. The method of claim 16, further comprising regulating a bottom hole pressure at a location of the fluid flow from the subterranean formation into the wellbore with a choke manifold in fluid communication with he an annulus defined between the string of drill pipe and the wellbore.

18. The method of claim 8, further comprising:
increasing an equivalent circulation density of a drilling fluid circulating within the wellbore until a pressure within the wellbore increases above a fracture pressure gradient of a subterranean formation penetrated by the wellbore; and
sensing at least one of noise and a temperature fluctuation within the wellbore with the one or more optical fibers, wherein the at least one of the noise and the temperature fluctuation is indicative of fluid flow from the wellbore into the subterranean formation.

19. The method of claim 18, further comprising regulating a bottom hole pressure at a location of the fluid flow from the wellbore into the subterranean formation with a choke manifold in fluid communication with an annulus defined between the string of drill pipe and the wellbore.

20. The method of claim 8, wherein at least one of the one or more optical fibers includes a Fiber Bragg Grating positioned at known location along a length of the at least one of the one or more optical fibers, the method further comprising obtaining at least one of localized noise and temperature measurements with the Fiber Bragg Grating.

21. The method of claim 8, wherein a wellbore liner is coupled to a distal end of the string of drill pipe, the method further comprising:
conveying the cable into the wellbore within the string of drill pipe and the wellbore liner; and
obtaining at least one of distributed acoustic, distributed temperature, and static strain measurements along the wellbore within the string of drill pipe and the wellbore liner with at least one of the one or more optical fibers.

22. The method of claim 8, wherein at least a portion of the wellbore is lined with casing, and wherein sensing the one or more well parameters with the one or more optical fibers comprises obtaining at least one of distributed acoustic and temperature measurements with at least one of the one or more optical fibers and thereby detecting fluid flow behind the casing.

23. The method of claim 8, wherein the cable is coupled to a wiper plug disposed within the string of drill pipe, the method further comprising:
pumping the wiper plug through the string of drill pipe and thereby displacing cement out a distal end of the string of drill pipe and into an annulus defined between the wellbore and the string of drill pipe; and
obtaining at least one of distributed acoustic and temperature measurements with at least one of the one or more optical fibers and thereby monitoring a progress of the cement within the annulus.
